(19) United States
(12) Patent Application Publication
(10) Pub. No.: US 2018/0032476 A1
(43) Pub. Date: Feb. 1, 2018

(54) DEVICE AND METHOD TO SOLVE DIFFERENT TYPES OF MATHEMATICAL PROBLEMS WITH STEP-BY-STEP EXPLANATIONS

(71) Applicant: Elizabeth Blancas Lopez, Pacifica, CA (US)

(72) Inventor: Elizabeth Blancas Lopez, Pacifica, CA (US)

(21) Appl. No.: 15/224,670

(22) Filed: Aug. 1, 2016

(51) Int. Cl. G06F 17/11

(52) U.S. Cl. CPC G06F 17/11

(57) ABSTRACT

A calculator that allows a user to solve different type of mathematical problems with a step-by-step explanation is provided. The calculator includes a display that (i) allows the user to provide inputs to the calculator by touching the display for solving a mathematical problem, and (ii) displays an output; a programmed chip that stores programs for solving the mathematical problem; a processor that processes the inputs based on the set of programs to solve the mathematical problem; a chip slot that is adapted to receive the programmed chip; and a virtual button that provides step-by-step explanation for solving the mathematical problem. When the user provides the inputs to the calculator, the processor executes the programs to solve the mathematical problem. The display displays the output of the solved mathematical problem. When the user presses the virtual button, the step-by-step explanation of the solved mathematical problem is displayed on the display.

### CROSS REFERENCE TO THE RELATED APPLICATION

This application claims priority to and the benefits of the provisional patent application No. “62/319,469” titled “CALTOUCH” filed in United States Patent and Trademark Office on “Apr. 7, 2016”. The specification of the above referenced patent application is incorporated herein by reference in its entirety.

### BACKGROUND

### Technical Field

The embodiment herein generally relates a calculator, and more particularly, a method and device to allow a user to perform several calculator operations on a single device.

### Description of the Related Art

A calculator is an electronic device that allows a user to perform mathematical calculations at all grade levels. The calculator solves mathematical problems including, without limiting, basic arithmetic or complex problems.

Calculators generally possess small screens and are bulky. Moreover, the aesthetic aspects of the present calculator are also outdated. The calculators are programmed to display an end result of the problem. The user does not understand the method of solving the problem. It becomes difficult in case of complex calculations to know the method of finding the solution to a specific problem.

A large variety of calculators are available in the market, depending upon the type of problem to be solved. The user needs to carry multiple calculators to solve different type of mathematical problems. Moreover, it becomes uneconomical for the user to buy more than one calculators to solve different type of mathematical problems. A lot of material is wasted for manufacturing more than one calculators for different operations.

Accordingly, there remains a need for an advanced calculator that displays step-by-step explanation.

### SUMMARY

In view of the foregoing, an embodiment herein provides a calculating device that allows a user to solve different type of mathematical problems with a step-by-step explanation. The calculating device includes a display, a charging port, a programmed chip, a processor, a chip slot, and a virtual button. The display (i) allows the user to provide inputs to the calculating device by touching the display for solving a mathematical problem, and (ii) displays an output. The charging port charges the calculating device. The programmed chip stores a set of programs for solving the mathematical problem. The processor processes the inputs based on the set of programs to solve the mathematical problem. The chip slot is adapted to receive the programmed chip. The virtual button provides a step-by-step explanation for solving the mathematical problem by selecting the virtual button by the user. When the user provides the inputs to the calculating device, the processor executes the set of programs to solve the mathematical problem. The display displays the output of the solved mathematical problem. When the user presses the virtual button, the step-by-step explanation of the solved mathematical problem is displayed on the display.

In one embodiment, the calculating device is a calculator, and the display is a touch screen display. The inputs are numerals and alphabets that are displayed on the display. In one embodiment, the mathematical problem is selected from a group, but not limited: arithmetic, calculus or differential equation. In another embodiment, the charging port is adapted to project the output from the display of the adaptive calculator on-to the screen of a personal digital assistance using a USB cable.

In one embodiment, the programmed chip includes a first programmed chip, a second programmed chip, and a third programmed chip. The first programmed chip stores a set of programs for solving arithmetic type of mathematical problems. The second programmed chip stores a set of programs for solving calculus type of mathematical problems. The third programmed chip stores a set of programs for solving differential equation type of mathematical problems.

In one embodiment, the output is a solution to the different type of mathematical problems. In another embodiment, the output is a graphical representation of the solution to the different type of mathematical problems. In another embodiment, the calculating device further includes an orientation sensor that rotates the graphical representation of the solution in a landscape mode when the user rotates the calculating device in the landscape mode.

In one embodiment, the calculating device further includes a set of speakers, a power button, and an earphone slot. The set of speakers assist the user to listen to a pre-recorded voice of the step-by-step explanation of the mathematical problem. The power button allows the user to turn ON/OFF the calculating device. The earphone slot allows the user to insert earphone's jack in the earphone slot and listen to the pre-recorded voice of the step-by-step explanation of the mathematical problem.

In another aspect, an adaptive calculator that allows a user to solve different type of mathematical problems with a step-by-step explanation is provided. The adaptive calculator includes a touch screen display, a USB charging port, a first programmed chip, a second programmed chip, a third programmed chip, a processor, a chip slot, and a virtual button. The touch screen display (i) allows the user to provide inputs to the calculator by touching the touch screen display for solving the different type of mathematical problems, and (ii) displays an output. In one embodiment, the USB charging port is provided that is adapted to (i) charge the adaptive calculator, and (ii) connect a personal digital assistant to the adaptive calculator using a USB cable. The first programmed chip stores a set of programs for solving arithmetic type of mathematical problems. The second programmed chip stores a set of programs for solving calculus type of mathematical problems. The third programmed chip stores a set of programs for solving differential equations type of mathematical problems.

The processor processes the inputs based on the set of programs to solve (i) the arithmetic type of mathematical problems, (ii) the calculus type of mathematical problems, and (iii) the differential equation type of mathematical problems. The chip slot is adapted to receive any one of (i) the first programmed chip, (ii) the second programmed chip, and (iii) the third programmed chip. The virtual button provides step-by-step explanation for solving the different type of mathematical problems by touching the virtual button by the user. When the user provides the inputs to the adaptive calculator, the processor executes the set of programs to solve the mathematical problem. The touch screen display displays the output of the solved mathematical problem. When the user presses the virtual button, the step-by-step explanation of the solved mathematical problem is displayed on the touch screen display. The set of speakers assists the user to listen to the pre-recorded voice of the step-by-step explanation of the mathematical problem.

In one embodiment, the adaptive calculator further includes a power button, and an earphone slot. The power button allows the user to turn the calculating device ON/OFF. The earphone slot allows the user to insert earphone's jack in the earphone slot and listen to the pre-recorded voice of the step-by-step explanation of the mathematical problem.

In another embodiment, the inputs are numerals and alphabets that are displayed on the touch screen display. In another embodiment, the output is a solution to the different type of mathematical problems. The output is a graphical representation of the solution to the different type of mathematical problems. The adaptive calculator further includes an orientation sensor that rotates the graphical representation of the solution in a landscape mode when the user rotates the adaptive calculator in the landscape mode.

In yet another aspect, a method of solving different type of mathematical problems with a step-by-step explanation is provided. The method includes following steps: (i) a programmed chip is inserted into a chip slot of an adaptive calculator; (ii) a mathematical problem is provided as input to the adaptive calculator via a touch screen display to process the mathematical problem; (iii) the mathematical problem is processed by a processor of the adaptive calculator to get a solution for the mathematical problem; (iv) the solution of the mathematical problem is displayed with the step-by-step explanations as output by the touch screen display; and (v) the graphical representation of the solution is displayed of the mathematical problem by the touch screen display.

In one embodiment, the mathematical problem is selected from a group comprising of arithmetic, calculus or differential equation. In another embodiment, the inputs are numerals and alphabets. The numerals and alphabets are displayed on the display.

In one embodiment, the programmed chip includes a first programmed chip, a second programmed chip, and a third programmed chip. The first programmed chip stores a set of programs for solving arithmetic type of mathematical problems. The second programmed chip stores a set of programs for solving calculus type of mathematical problems. The third programmed chip stores a set of programs for solving differential equation type of mathematical problems.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a perspective view of an adaptive calculator with one or more programmed chips to solve mathematical problems with a step-by-step explanation according to an embodiment herein;

FIG. 2A is a diagrammatic representation of a top view of the adaptive calculator of FIG. 1 according to an embodiment herein;

FIG. 2B is a diagrammatic representation of a rear view of the adaptive calculator of FIG. 1 according to an embodiment herein;

FIG. 2C is a diagrammatic representation of a left side view of the adaptive calculator of FIG. 1 according to an embodiment herein;

FIG. 2D is a diagrammatic representation of a right side view of the adaptive calculator of FIG. 1 according to an embodiment herein;

FIG. 3 is a flow diagram illustrating a method of solving different types of mathematical problems using an adaptive calculator according to an embodiment herein;

FIG. 4A is a user interface view of the adaptive calculator of FIG. 1 when the user provides an input to solve arithmetic mathematical problem with step-by-step explanation according to an embodiment herein;

FIG. 4B is a user interface view of the adaptive calculator of FIG. 1 when the user activates the virtual button to view the step-by-step explanation of the arithmetic mathematical problem with according to an embodiment herein; and

FIG. 4C is a user interface view of the adaptive calculator of FIG. 1 that displays the solution to the arithmetic mathematical problem according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

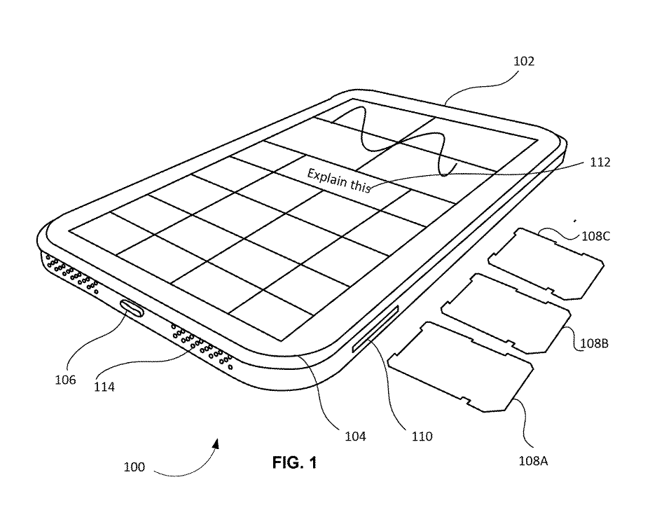

As mentioned, there remains a need for simple an advanced calculator. The embodiments herein achieve this by providing an adaptive calculator that allows a user to solve various types of mathematical problems on a single device. Referring now to the drawings, and more particularly to FIGS. 1 through 4C, where similar reference characters denote corresponding features consistently throughout the figures, there are shown preferred embodiments.

FIG. 1 is a perspective view 100 of an adaptive calculator 102 with one or more programmed chips 112 to solve mathematical problems with a step-by-step explanation according to an embodiment herein. The adaptive calculator 102 includes a display 104, a charging port 106, a first programmed chip 108A, a second programmed chip 108B, a third programmed chip 108C, a chip slot 110, a virtual button 112, and a set of speakers 114. The display 104 is a touch screen display that allows a user to provide inputs to the adaptive calculator 102 for the mathematical problems. In one embodiment, the adaptive calculator 102 displays numerals and alphabets on the display 104. The user provides input to the adaptive calculator 102 by touching numerals and alphabets on the display 104. In one embodiment, the inputs may be numerals and alphabets for the mathematical problems. In another embodiment, the display 104 is made from glass. The adaptive calculator 102 is powered by one or more rechargeable batteries (not shown in the FIG. 1). The one or more rechargeable batteries of the adaptive calculator 102 are charged via the charging port 106.

The first programmed chip 108A stores a set of programs for solving arithmetic mathematical problems. For example, the first programmed chip 108A is adapted to solve the following problem:

$$\begin{matrix}{A}^{2} * {A}^{3} = ? \\ = {A}^{x} * {A}^{y} \\ = {A}^{( x + y )}\end{matrix}$$

$${A}^{2} * {A}^{3} = {A}^{( x + y )}$$

The adaptive calculator 102 makes use of letters such as x, y and z, instead of using numbers to avoid cheating.

The second programmed chip 108B stores a set of programs for solving calculus problems of mathematics. For example, the second programmed chip 108B is adapted to solve the following problem:

$$\begin{matrix}\int sin 2 x dx = ? \\ = \int sin Axdx \\ = - ( 1 \text{/} A ) cos A x + C\end{matrix}$$

$$\int sin 2 xdx = - ( 1 \text{/} A ) cos Ax + C$$

The adaptive calculator 102 makes use of letters such as x, y and z, instead of using numbers to avoid cheating.

The third programmed chip 108C stores a set of programs for solving differential equations of mathematics. For example, the third programmed chip 108B is adapted to solve the following problem:

$$\begin{matrix}d \text{/} dx ( 2 {x}^{2} + 5 x + 7 ) = ? \\ = d \text{/} dx ( {Ax}^{2} + Bx + C ) \\ = 2 Ax + B\end{matrix}$$

$$d \text{/} dx ( 2 {x}^{2} + 5 x + 7 ) = 2 Ax + B$$

The adaptive calculator 102 makes use of letters such as x, y and z, instead of using numbers to avoid cheating.

The chip slot 110 is adapted to receive any one programmed chip from the first programmed chip 108A, the second programmed chip 108B, and the third programmed chip 108C at a time. Any one programmed chip is selected based on the desired mathematical problem to be solved. The first programmed chip 108A is inserted in the chip slot 110 to solve arithmetic problems of mathematics. The first programmed chip 108A is removed from the chip slot 110, and the second programmed chip 108B is inserted in the chip slot 110 to solve calculus problems of mathematics. The second programmed chip 108B is removed from the chip slot 110, and the third programmed chip 108C is inserted in the chip slot 110 to solve differential equation problems of mathematics. In one embodiment, the adaptive calculator 102 may include ‘n’ number of programmed chips with ‘n’ number of solutions to solve different types of mathematical problems stored in ‘n’ number of programmed chips.

The virtual button 112 depicts a name “explain this” that displays the step-by-step explanation to the solution to the problem upon touching the virtual button 112. The adaptive calculator 102 further includes an orientation sensor (not shown). The orientation sensor senses the orientation of the adaptive calculator 102 and expands the graphs when the adaptive calculator 102 is rotated to sides. In one embodiment, the display 104 is less pixalated. In another embodiment, the body of the adaptive calculator 102 is made up of materials including, without limiting, stainless steel. The set of speakers 114 are connected to the bottom of the adaptive calculator 102. The user listens to the step-by-step explanation to the solution to the problem in the form of a pre-recorded voice from the set of speakers 114. In one embodiment, the charging port 106 is adapted to connect a USB cord with a PDA (personal digital assistant) to project the mathematical calculations results of the problem on a PDA screen

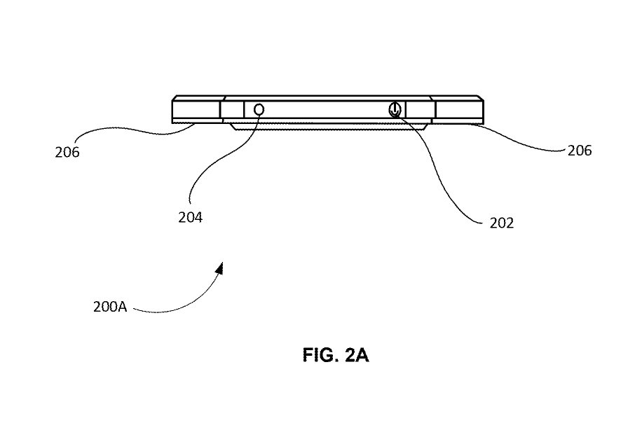

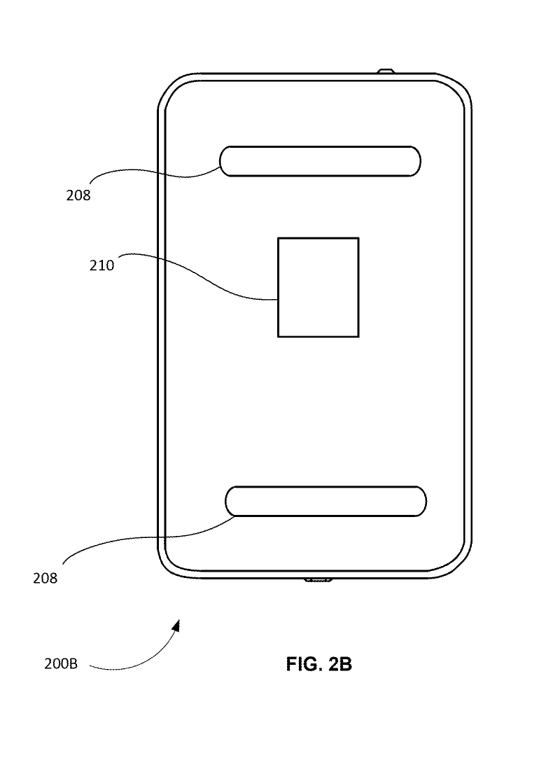

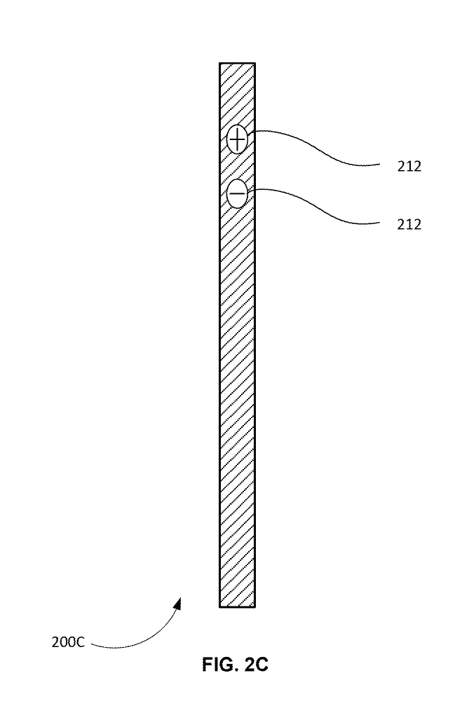

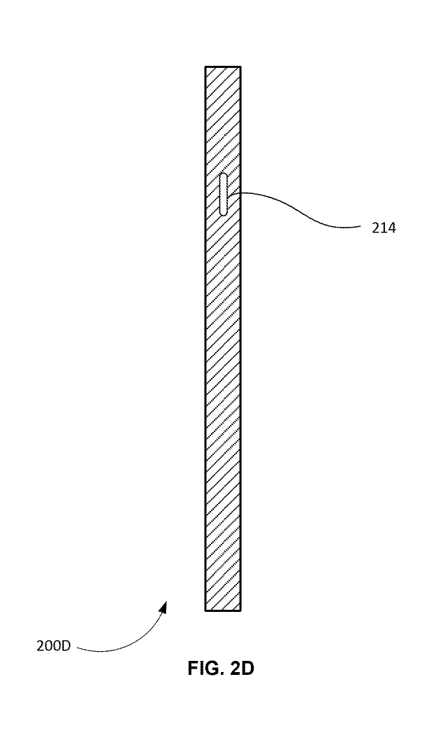

FIG. 2A is a diagrammatic representation of a top view 200A of the adaptive calculator 102 of FIG. 1 according to an embodiment herein. The adaptive calculator 102 further includes a power button 202, an earphone slot 204 and rubber grips 206. The power button 202 turns ON/OFF the adaptive calculator 102. The user listens to the step-by-step solution of the problem via the earphones plugged in the earphone slot 204 instead of the set of speakers 114. The Rubber grips 206 help the user to maintain the grip onto the adaptive calculator 102.

FIG. 2B is a diagrammatic representation of a rear view 200B of the adaptive calculator 102 of FIG. 1 according to an embodiment herein. The adaptive calculator 102 further includes a set of rubber pads 208 and a blank space 210 for the logo. The set of rubber pads 208 protects the rear surface of the adaptive calculator 102 from getting scratches. The blank space 210 incorporates the logo of the company.

FIG. 2C is a diagrammatic representation of a left side view 200C of the adaptive calculator 102 of FIG. 1 according to an embodiment herein. The adaptive calculator 102 further includes a set of two buttons 212 on the left side of the adaptive calculator 102. The user presses the set of two buttons 212 to adjust the brightness of the display 104.

FIG. 2D is a diagrammatic representation of a right side view 200D of the adaptive calculator 102 of FIG. 1 according to an embodiment herein. The adaptive calculator 102 further includes a lock screen button 214. The user presses the lock screen button 214 to lock the screen on either standard mode or landscape mode to avoid any unwanted switch of screen modes of the display 104.

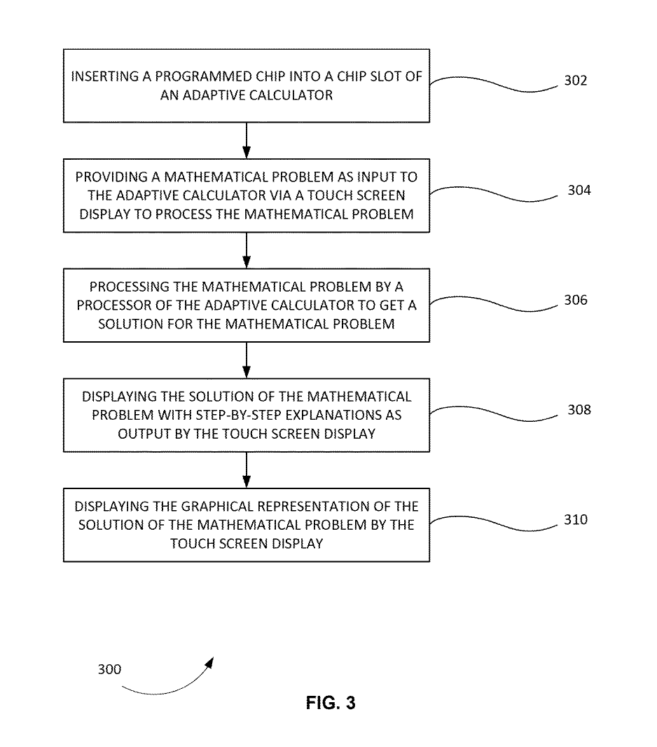

FIG. 3 is a flow diagram illustrating a method of solving different types of mathematical problems using an adaptive calculator 102 according to an embodiment herein.

In step 302, a programmed chip 108 is inserted into a chip slot 110 of the adaptive calculator 102. In one embodiment, the programmed chip 108 may be a first programmed chip 108A, a second programmed chip 108B or a third programmed chip 108C. In one embodiment, the first programmed chip 108A stores a set of programs for solving arithmetic type of mathematical problems. In another embodiment, the second programmed chip 108B stores a set of programs for solving calculus type of mathematical problems. In another embodiment, the third programmed chip 108C stores a set of programs for solving differential equation type of mathematical problems. In step 304, the input for the mathematical problem is provided to the adaptive calculator 102 by a user via a display 104 to process the mathematical problem. In one embodiment, the display 104 is a touch screen display. In step 306, the mathematical problem is processed by a processor of the adaptive calculator 102 to get a solution to the mathematical problem. In step 308, the solution to the mathematical problem is displayed on the display 104. The solution is displayed as a graph as shown by step 310. In another embodiment, the user may demand a step-by-step explanation to the solution of the mathematical problem by touching a virtual button 112.

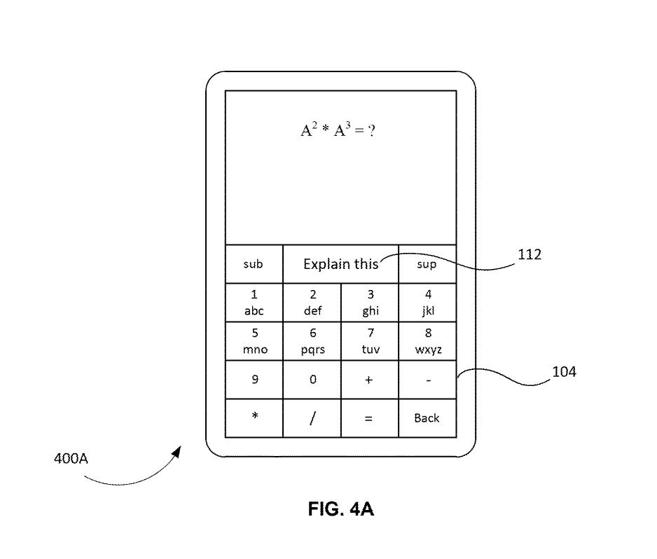

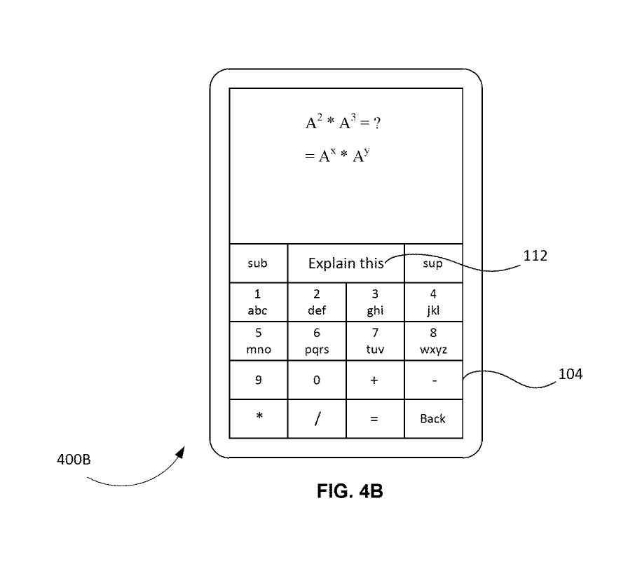

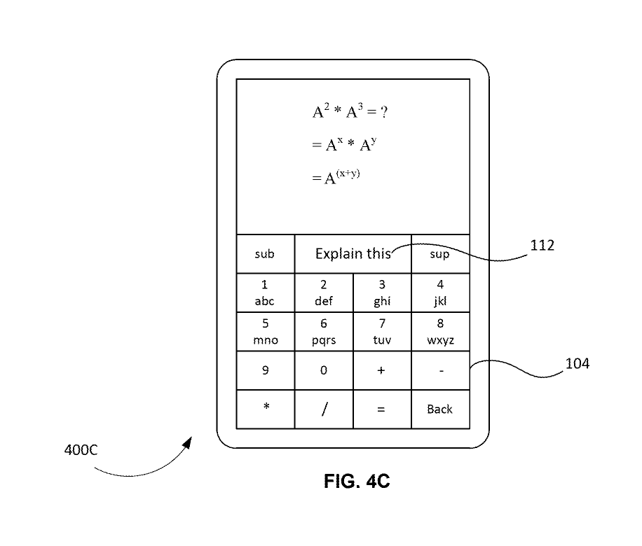

FIG. 4A is a user interface view 400A of the adaptive calculator 102 of FIG. 1 when the user provides an input to solve arithmetic mathematical problem with step-by-step explanation according to an embodiment herein. The user interface view 400A depicts an option for the user to provide input to the adaptive calculator 102 to solve the arithmetic mathematical problem. The input is displayed on the display of the adaptive calculator.

FIG. 4B is a user interface view 400B of the adaptive calculator 102 of FIG. 1 when the user activates the virtual button 112 to view the step-by-step explanation of the arithmetic mathematical problem with according to an embodiment herein. The user interface view 400B depicts the steps to solve the arithmetic mathematical problem.

FIG. 4C is a user interface view 400C of the adaptive calculator 102 of FIG. 1 that displays the solution to the arithmetic mathematical problem according to an embodiment herein. The user depicts the solution to the arithmetic mathematical problem from the display 104. In one embodiment, the step-by-step explanation is represented on the display 104 as an image.

The adaptive calculator 102 is a modern day's calculator in respect that the adaptive calculator 102 possesses a bigger display screen. The display 104 is a full touch enabled display. Less pixalated display 104 enhances the image quality of the graphs being represented on the display 104. The adaptive calculator 102 not only provides the answer to a problem, but also displays the method of solving the problem for better understanding of the user. The adaptive calculator 102 makes use of letters such as x, y and z, instead of using numbers to avoid cheating. The user just needs to buy a programmed chip 108 of required problem to change the problem to be solved, thereby cutting the cost of buying a whole new calculator as well as reducing the material requirement for multiple calculators. To look more attractive, the rear side of the adaptive calculator 102 is provided with colored back panels. The adaptive calculator 102 employs an in-built battery which is chargeable using a charger, eliminating the replacement of batteries. The user may connect the adaptive calculator 102 to a PDA to project the solution of the problem from the display 104 of the adaptive calculator 102 on-to the screen of the PDA to have a better experience of image viewing on a much bigger screen. The adaptive calculator 102 solves the problems ranging from basic mathematics to the complex equations.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A calculating device that allows a user to solve different type of mathematical problems with a step-by-step explanation, wherein said calculating device comprises:
a display that (i) allows said user to provide inputs to said calculating device by touching said display for solving a mathematical problem, and (ii) displays an output;
a charging port that charges said calculating device;
a programmed chip that stores a set of programs for solving said mathematical problem;
a processor that processes said inputs based on said set of programs to solve said mathematical problem;
a chip slot that is adapted to receive said programmed chip; and
a virtual button that provides step-by-step explanation for solving said mathematical problem by selecting said virtual button by said user,
wherein when said user provides said inputs to said calculating device, said processor executes said set of programs to solve said mathematical problem, wherein said display displays said output of said solved mathematical problem,
wherein when said user presses said virtual button, said step-by-step explanation of said solved mathematical problem is displayed on said display.

2. The calculating device of claim 1, wherein said calculating device is a calculator.

3. The calculating device of claim 1, wherein said display is a touch screen display.

4. The calculating device of claim 1, wherein said charging port is adapted to project said output from said display of said adaptive calculator on-to a screen of a personal digital assistance using a USB cable.

5. The calculating device of claim 1, wherein said inputs are numerals and alphabets, wherein said numerals and alphabets are displayed on said display.

6. The calculating device of claim 1, wherein said mathematical problem is selected from a group comprising of arithmetic, calculus or differential equation.

7. The calculating device of claim 1, wherein said programmed chip comprises :
a first programmed chip that stores a set of programs for solving arithmetic type of mathematical problems;
a second programmed chip that stores a set of programs for solving calculus type of mathematical problems; and
a third programmed chip that stores a set of programs for solving differential equation type of mathematical problems.

8. The calculating device of claim 1, wherein said output is a solution to said different type of mathematical problems, wherein said output is a graphical representation of said solution to said different type of mathematical problems.

9. The calculating device of claim 7, wherein said calculating device further comprises:
an orientation sensor that rotates said graphical representation in a landscape mode when said user rotates said calculating device in said landscape mode.

10. The calculating device of claim 1, wherein said device further comprises :
a set of speakers that assists said user to listen to a pre-recorded voice of said step-by-step explanation of said mathematical problem;
a power button that allows said user to turn ON/OFF said calculating device; and
an earphone slot that allows said user to insert earphone's jack in said earphone slot and listen to said pre-recorded voice of said step-by-step explanation of said mathematical problem.

11. An adaptive calculator that allows a user to solve different type of mathematical problems with a step-by-step explanation, wherein said calculator comprises:
a touch screen display that (i) allows said user to provide inputs to said calculator by touching said touch screen display for solving said different type of mathematical problems, and (ii) displays an output;
a USB charging port that is adapted to (i) charge said adaptive calculator, and (ii) connect a personal digital assistant to said adaptive calculator using a USB cable;
a first programmed chip that stores a set of programs for solving arithmetic type of mathematical problems;
a second programmed chip that stores a set of programs for solving calculus type of mathematical problems;
a third programmed chip that stores a set of programs for solving differential equations type of mathematical problems;
a processor that processes said inputs based on said set of programs to solve (i) said arithmetic type of mathematical problems, (ii) said calculus type of mathematical problems, and (iii) said differential equation type of mathematical problems;
a chip slot that is adapted to receive any one of (i) said first programmed chip, (ii) said second programmed chip, and (iii) said third programmed chip;
a virtual button that provides step-by-step explanation for solving said different type of mathematical problems by touching said virtual button by said user, wherein when said user provides said inputs to said calculator, said processor executes said set of programs to solve said mathematical problem, wherein said touch screen display displays said output of said solved mathematical problem,
wherein when said user presses said virtual button, said step-by-step explanation of said solved mathematical problem is displayed on said touch screen display; and
a set of speakers that assists said user to listen to said pre-recorded voice of said step-by-step explanation of said mathematical problem.

12. The adaptive calculator of claim 10, wherein said adaptive calculator further comprises:
a power button that allows said user to turn said calculating device ON/OFF; and
an earphone slot that allows said user to insert earphone's jack in said earphone slot and listen to said pre-recorded voice of said step-by-step explanation of said mathematical problem.

13. The adaptive calculator of claim 10, wherein said inputs are numerals and alphabets, wherein said numerals and alphabets are displayed on said touch screen display.

14. The adaptive calculator of claim 10, wherein said output is a solution to said different type of mathematical problems.

15. The adaptive calculator of claim 10, wherein said output is a graphical representation of said solution to said different type of mathematical problems, wherein said adaptive calculator further comprises:
an orientation sensor that rotates said graphical representation in a landscape mode when said user rotates said adaptive calculator in said landscape mode.

16. A method of solving different type of mathematical problems with a step-by-step explanation, said method comprising:
inserting a programmed chip into a chip slot of an adaptive calculator;
providing a mathematical problem as input to said adaptive calculator via a touch screen display to process said mathematical problem;
processing said mathematical problem by a processor of said adaptive calculator to get a solution for said mathematical problem;
displaying said solution of said mathematical problem with said step-by-step explanations as output by said touch screen display; and
displaying a graphical representation of said solution of said mathematical problem by said touch screen display.

17. The method of claim 15, wherein said mathematical problem is selected from a group comprising of arithmetic, calculus or differential equation

18. The method of claim 15, wherein said inputs are numerals and alphabets, wherein said numerals and alphabets are displayed on said touch screen display.

19. The method of claim 15, wherein said programmed chip comprises:
a first programmed chip that stores a set of programs for solving arithmetic type of mathematical problems;
a second programmed chip that stores a set of programs for solving calculus type of mathematical problems; and
a third programmed chip that stores a set of programs for solving differential equation type of mathematical.
